(19) United States
(12) Patent Application Publication
(10) Pub. No.: US 2026/0016128 A1
(43) Pub. Date: Jan. 15, 2026

(54) IN-LINE ELECTROCHEMICAL CONVERTER FOR IN-SITU GENERATION OF ACTIVE CHEMICALS

(71) Applicant: ChampionX LLC, Sugar Land, TX (US)

(72) Inventor: Jeremy MOLONEY, Katy, TX (US)

(73) Assignee: ChampionX LLC, Sugar Land, TX (US)

(21) Appl. No.: 19/236,629

(22) Filed: Jun. 12, 2025

Related U.S. Application Data
(60) Provisional application No. 63/671,586, filed on Jul. 15, 2024.

(51) Int. Cl. F17D 3/12

(52) U.S. Cl. CPC F17D 3/12

(57) ABSTRACT

The disclosure pertains to methods and systems for converting inactive chemicals into active chemicals in-situ for treating oil and gas pipelines, other industrial systems, or sanitizing surfaces. A method of treating an oil and gas pipeline is disclosed. The method may include feeding an inactive additive through a first conduit and into a second conduit, wherein the second conduit is in fluid communication with the first conduit and the oil and gas pipeline. The method also includes converting the inactive additive into an active additive within the second conduit and introducing the active additive into the oil and gas pipeline.

### TECHNICAL FIELD

The present disclosure generally relates to in-situ generation of active chemicals. More particularly, the disclosure pertains to methods and systems for converting inactive chemicals into active chemicals in-situ for treating pipelines, such as oil and/or gas pipelines, or other industrial systems and devices.

### BACKGROUND

Oilfield treatment chemicals are widely used to attend to an array of problems in the various processes of drilling, transportation, storage and refining in the oil and gas industry. Examples of chemicals used include corrosion inhibitors, oxygen scavengers, biocides, hydrogen sulfide scavengers, hydrate inhibitors, scale inhibitors, demulsifiers, paraffin inhibitors, wax inhibitors, flow improvers, foamers, and antifoams. These chemicals are usually applied via direct injection of a liquid chemical product from a storage tank into the pipeline stream.

Some chemicals are known to be effective in certain applications; however, the risks associated with handling hazardous chemicals limit or altogether prevent their use. For example, acrolein is known to be an effective hydrogen sulfide scavenger, but acrolein and many hydrogen sulfide scavengers are also known to be toxic and are more complicated to handle than other oilfield treatment chemicals. Formaldehyde, amongst other chemicals, is known to be an effective biocide. However, formaldehyde and many biocides are also known to be more toxic and less safe than other oilfield treatment chemicals.

### BRIEF SUMMARY

In some embodiments, the present disclosure provides a method of treating a pipeline. The method may include feeding an inactive additive through a first conduit and into a second conduit, wherein the second conduit is in fluid communication with the first conduit and is connected to the pipeline; converting the inactive additive into an active additive with an electrochemical converter in the second conduit; and introducing the active additive into the pipeline.

In some embodiments, the present disclosure provides a system for treating a pipeline. The system may include a first conduit; a second conduit in fluid communication with the first conduit and the pipeline; and an electrochemical converter disposed within the second conduit.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE DRAWINGS

A detailed description of the invention is hereafter described with specific reference being made to the drawings in which:

FIG. 1 shows a schematic of an embodiment of a system including an electrochemical converter and optional heating device; and

FIG. 2 shows a schematic of another embodiment of a system including an electrochemical converter.

### DETAILED DESCRIPTION

Various embodiments are described below. The relationship and functioning of the various elements of the embodiments may better be understood by reference to the following detailed description. However, embodiments are not limited to those explicitly described below. In certain instances, details may have been omitted that are not necessary for an understanding of embodiments disclosed herein.

The present disclosure provides systems and methods for converting inactive additives into active additives in situ. The inactive additives may be converted, or at least partially converted, into active additives in any medium, such as water, gas, and/or oil. The medium may be contained in any device, such as a storage vessel, a tank, or a pipeline.

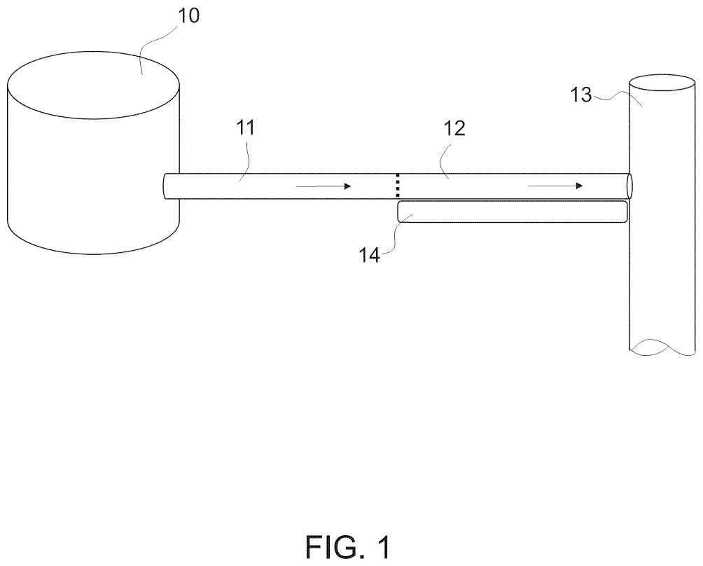

FIG. 1 shows an illustrative embodiment including a tank 10 for storing an inactive additive and/or feeding an inactive additive into a first conduit 11. Conversion of the inactive additive into an active additive may occur in, for example, the first conduit 11 and/or the second conduit 12, which are in fluid communication with each other. In some embodiments, the first conduit 11 and/or the second conduit 12 comprise a one-way valve. The first conduit 11 and/or the second conduit 12 also comprise an electrochemical converter.

The electrochemical converter comprises a standard or non-standard electrochemical cell. It may also comprise an anode, a cathode, and other optional electrodes, such as a reference electrode and/or a counter electrode. All of these components may be disposed within the conduit.

For example, the conduit housing the electrochemical converter cell may include one or more one way valves connecting it to the delivery inactive additive pipework, which may be upstream, as well as the device (e.g., a pipeline or container) containing the fluids to be treated by the generated active additive. Isolation joints, such as gaskets, may be incorporated between the conduit containing the electrochemical cell and the infrastructure upstream and downstream of it.

The assembly of the electrochemical converter cell may include one or more probes being inserted into the conduit with electrical isolation to the conduit material in a similar way that a corrosion monitoring probe (such as an electrical resistant corrosion monitoring probe or a linear polarization corrosion monitoring probe) is inserted into a pipeline. This enables electrical contact being made to the external source outside of the conduit to the electrodes within the conduit. An individual probe may contain all electrodes (anode, cathode and reference electrode when desired) or a separate probe for each of the electrodes may be incorporated.

The electrodes may be in various forms including, but not limited to, rod, plate, and/or gauze. The materials of these electrodes may include, for example, a metal, such as platinum, graphite, steel, or any combination thereof.

The electrochemical cell may operate under potentiostatic or galvanostatic modes. Power may be delivered to the cell by, for example, electricity, battery, and/or renewable options, such as solar, wind, etc.

The incorporation of in-line catalysts/electrocatalysts may be considered to reduce electrical/power requirements. The cell may be left at ambient temperature or include optional heating to further aid chemical conversion.

In operation, the inactive additive may be pumped from the storage tank 10 through the in-line segment containing the electrochemical array. The electrode potential on the converting electrode is set appropriately to allow the conversion of the selected chemical to the chemical of interest. The conversion of the selected chemical to the chemical of interest may be an oxidation or reduction process, for example.

To convert the inactive additive into an active additive, a potential may be applied across the anode and the cathode, for example. The active additive may then be introduced into any type of device or vessel, such as a pipeline 13.

While FIG. 1 depicts an embodiment including both a first 11 and second conduit 12, a system of the present disclosure need not include both a first 11 and a second conduit 12. Instead, a system may include, for example, a tank in fluid communication with a first conduit 11, wherein the first conduit is in fluid communication with a device, such as a pipeline 13. In this embodiment, the first conduit 11 may comprise the electrochemical converter and optional heating device 14.

In embodiments including both first 11 and second conduits 12, the second conduit 12 need not be connected to an absorber or any other type of separation unit, although it could be. As such, once the active additive exits the second conduit 12, it can be immediately introduced into a device, such as a pipeline 13, applied onto a surface, and/or introduced into an aqueous system without passing through an absorber.

In some embodiments, there are no components between the second conduit 12 and the device. As such, the active additive exits the second conduit 12 and flows directly into the device, such as a pipeline 13, without passing through and/or by any other components.

In some embodiments, the pipeline 13 may be a pipeline comprising a medium, such as oil, gas, and/or water. The water may be, for example, produced water, water pumped into a subterranean reservoir, brine, freshwater, surface water, cooling water, ground water, seawater, or any combination thereof. The oil may comprise, for example, crude oil, refined oil, a liquid hydrocarbon oil, gasoline, kerosene, a fuel oil, a refined petroleum product, or any combination thereof. The gas may comprise, for example, a hydrocarbon gas (e.g., methane, ethane, propane, butane), hydrogen, carbon dioxide, ammonia, natural gas, or any combination thereof.

FIG. 1 also shows an optional heating device 14, which may be positioned adjacent to the second conduit 12 (or first conduit 11 if the system does not comprise a second conduit 12). The heating device 12 provides heat to the contents of the second conduit 12 and may assist in the conversion of the inactive additive to the active additive. A system of the present disclosure may include more than one heating device 14 and each heating device may be positioned anywhere in the systems disclosed herein.

The heating device 14 may be any device that is capable of heating the contents inside of the second conduit 12, such as a heating cable. Pipe heating may be accomplished by various means, such as using thermal, microwave, or laser devices. For example, commercially available heat tracing and line heating products can be used, such as Thermon's MIQ™ mineral insulated cables, which can maintain the temperature of a conduit up to about 500° C. The cables convert electrical energy to heat and are manufactured using Alloy 825, a high nickel/chromium alloy ideally suited for high temperature service that offers exceptional resistance to stress corrosion in chloride, acid, salt, and alkaline environments.

In some embodiments, the second conduit 12 may be a double containment pipe where an inner pipe is disposed within a second pipe with a larger diameter. The inactive additive can be fed through the inner pipe and a heating fluid may be fed through the second pipe to heat the inner pipe. In some embodiments, the heating device 14 may be the second pipe of the double containment pipe.

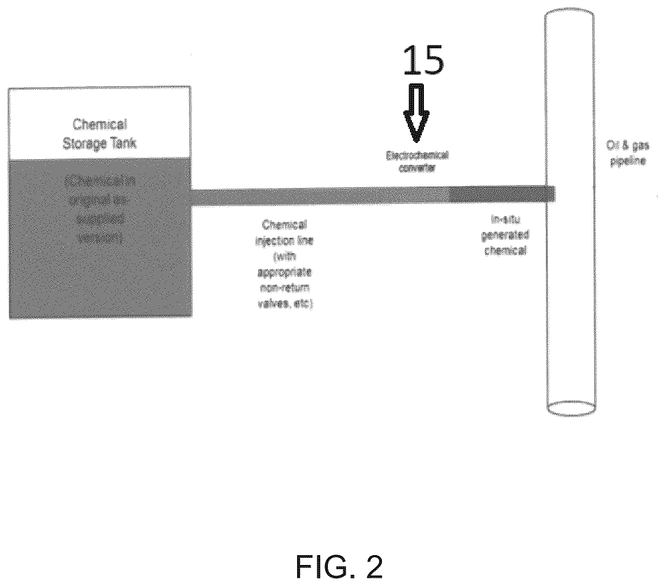

FIG. 2 shows another embodiment of a system of the present disclosure excluding the optional heating device. In the system of FIG. 2, the inactive additive may be stored in the storage tank 10. As desired, inactive additive may be transported from the tank 10, through a chemical injection line/first conduit 11. The inactive additive may flow through the chemical injection line 11 into a second conduit 12 comprising the electrochemical converter 15. As previously described, the electrochemical converter 15 may transform the inactive additive into an active additive, which may then flow into any device in fluid communication with the second conduit 12, such as a pipeline 13.

In some embodiments, the system need not include a second conduit 12. In such a system, the tank 10 may be in fluid communication with the device (e.g., pipeline) via a first conduit 11, which may comprise the electrochemical converter 15. In any of the embodiments disclosed herein, the first 11 and/or second conduit 12 may include a one-way valve to prevent backflow of the inactive or active additive.

As used herein, an “inactive additive” refers to a chemical that is less effective at the same dosage level than an “active additive” into which the inactive additive is converted. For example, the active additive may be a corrosion inhibitor that reduces the corrosion rate of metal, whereas the inactive additive may not reduce the corrosion rate of the metal, or may reduce the corrosion rate to a lesser extent, if added at the same dosage level as the active additive.

In some embodiments, the inactive additive may be about 0% to about 90% as effective as the active additive. In some embodiments, the inactive additive may be about 0% to about 80%, about 0% to about 70%, about 0% to about 60%, about 0% to about 50%, about 0% to about 40%, about 0% to about 30%, about 0% to about 20%, or about 0% to about 10% as effective as the active additive.

Inactive additives include any chemical compounds or compositions that breakdown or decompose into an active additive, such as a compound or composition that has greater efficacy than the inactive additive. Illustrative, non-limiting examples of inactive additives include glycerol, glyceraldehyde, hexamethylenetetramine, triazine, and methanol. Illustrative, non-limiting examples of active additives include acrolein, formaldehyde, ammonia, or any combination thereof.

Acrolein is known to be an effective hydrogen sulfide scavenger and biocide. However, acrolein (like many other hydrogen sulfide scavengers and biocides) is known to be toxic and less safe to handle than other oilfield treatment chemicals. The presently disclosed systems and methods allow acrolein, among other chemicals, to be generated in situ by electrooxidation of the appropriate starting chemical(s) through the application of an appropriate potential across electrodes, which would occur in the electrochemical converter section of the systems disclosed herein.

With the embodiments disclosed herein, much less toxic chemicals (but also much less effective as biocides, hydrogen sulfide scavengers, etc.) can be used, handled, and stored, and though the use of the internal electrochemical converter, more potent chemicals (active additives) can be generated in situ.

Active additives may comprise, for example, a hydrogen sulfide scavenger, a biocide, a corrosion inhibitor, and any combination thereof.

An example using glycerol or glyceraldehyde, which are known to be used in food, beverage, and medical applications, and therefore are relatively benign compared with many oilfield chemicals, is given below:

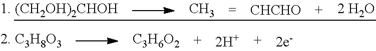

Glycerol and/or glyceraldehyde can be electrochemically converted to acrolein. This conversion typically involves using an electrochemical cell where glycerol and/or glyceraldehyde is subjected to an electric current in the presence of suitable electrodes and an electrolyte. The process involves oxidation of glycerol and/or glyceraldehyde to form acrolein. However, precise conditions and electrode materials may vary depending on the specific electrochemical setup and desired reaction conditions.

Glyceraldehyde, for example, may be oxidized to form acrolein. In the process, glyceraldehyde loses electrons and undergoes an increase in oxidation state, leading to the formation of acrolein. The oxidation potential of glycerol/glyceraldehyde to acrolein depends on the specific experimental conditions, such as the solvent, temperature, pH, and presence of catalysts or electrodes. However, generally, the oxidation potential for this conversion falls within the range of around +0.4 to +1.0 volts versus the standard hydrogen electrode (SHE) reference. Specific values can vary based on the experimental setup and reaction conditions.

Other examples involve the use of hexamethylenetetramine (HMTA), also known as methenamine. Electrochemical generation of ammonia from HMTA may assist in pH neutralization of fluids to aid in corrosion control. Ammonia vapor generated may assist in top-of-the-line corrosion control while dissolution in a low pH liquid may help in reducing bottom-of-the-line corrosion.

Electrochemical generation of formaldehyde, which has well-known biocidal properties, from HMTA may assist in treating bacteria and associated problems in, for example, oil and gas pipleines.

HMTA can also undergo electrochemical conversion to produce ammonia. This process involves the reduction of HMTA at the cathode, leading to the release of ammonia gas. The reaction can be represented as follows:

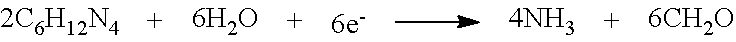

In this reaction, HMTA is reduced by gaining electrons (e⁻) at the cathode. Ammonia is produced along with formaldehyde.

As an additional example, methanol can be electrochemically converted to formaldehyde under certain conditions. One common method involves the electrochemical oxidation of methanol at the anode. The reaction typically occurs in an alkaline medium and involves the following steps oxidizing methanol at the anode to form formaldehyde and release electrons:

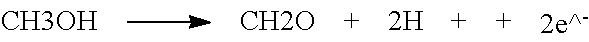

The intermediate formed in the oxidation step undergoes further reaction to produce formaldehyde:

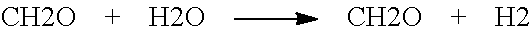

This electrochemical conversion process can be carried out in an electrolytic cell using suitable electrodes and an electrolyte solution containing methanol. The exact conditions, including electrode materials, pH, temperature, and applied potential, may vary depending on the specific setup and desired reaction parameters.

Any conduit disclosed herein may comprise an electrolyte solution. Electrolyte solutions of the present disclosure may comprise methanol, as noted above, and/or glycerol, glyceraldehyde, hexamethylenetetramine, and/or any combination thereof.

In addition to electrochemical conversion, the present disclosure contemplates optional heating, which may be used to generate active additives. For example, when glycerol is heated to a temperature of about 280° C., acrolein and water are produced. Acrolein can be added directly to oil, gas, or water to react with and remove hydrogen sulfide. Acrolein is electrophilic and reacts with thiols, while glycerol does not react with thiols under the same conditions.

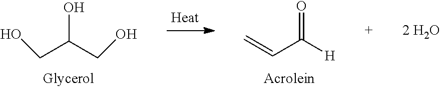

In some embodiments, the method may include heating a medium flowing through a conduit, such as the first and/or second conduit, to a temperature of from about 50° C. to about 500° C. For example, the medium may be heated to a temperature of about 280° C., about 250° C., about 200° C., or about 300° C. In some embodiments, the medium may be heated to a temperature of about 200° C. to about 300° C.

In some embodiments, the inactive additive may be methanol and the active additive may be formaldehyde. Methanol decomposes into formaldehyde and hydrogen when heated to a temperature above about 250° C. Formaldehyde can be used, for example, as an effective biocide.

Alternatively, formaldehyde can be generated by heating triazine. At temperatures greater than about 250° C., triazine breaks down into formaldehyde and a primary amine. In some embodiments, the inactive additive may be triazine and the active additive may be formaldehyde.

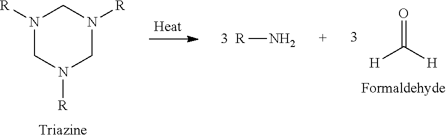

In some embodiments, the active additive may be a corrosion inhibitor. Amines and ammonia neutralize acidic solutions and can control corrosive environments. For example, ammonia can raise the pH of a fluid by neutralizing acids.

HMTA is commonly generated by reacting ammonia with formaldehyde. At high temperatures, HMTA breaks down into its constituent parts of ammonia and formaldehyde. At temperatures of between about 200 to 300° C., HMTA decomposition produces mainly ammonia and formaldehyde. In turn, the ammonia generated can raise the pH to neutralize acidic fluids. Ammonia vapors may assist in neutralizing acidic fluids in “top-of-the-line” (TOL) corrosion, which is known to be particularly difficult to mitigate with conventional continuous corrosion inhibitors.

Ammonia (NH₃) is an inorganic compound that boils at −28° F. at a pressure of 1 atmosphere. The ammonia gas may come into contact with hydrocarbons in a subterranean formation and react in-situ with naphthenic acid in the hydrocarbons to form surfactants. These surfactants are water-wetting and oil emulsifying, thereby facilitating the formation of an oil-in-water emulsion. The oil-in-water emulsion has a much lower viscosity than an oil continuous phase, such that the emulsion drains efficiently from the formation.

In some embodiments, a catalyst may be used. Catalytic material can be deposited on a porous monolith support, and the support can be disposed within a conduit, such as the first and/or second conduit. The inactive additive may flow into the conduit, contact the catalyst, and convert into an active additive, for example, at a lower temperature or electrical potential.

A method disclosed herein may optionally include determining a temperature of a medium flowing through a conduit. The temperature of the medium can be determined using any means available to one of ordinary skill in the art. For example, a thermocouple may be inserted through the wall of a conduit to directly measure the medium temperature. Alternatively, the correlation between the medium temperature and the temperature of the wall of the conduit could be determined so that a thermocouple could measure the temperature of the wall of the conduit to determine the medium temperature.

In addition to methods, the present disclosure provides systems for treating devices, such as pipelines. A system for treating a device comprises a first conduit, a second conduit in fluid communication with the first conduit and the device, and an electrochemical converter disposed within the second conduit. In some embodiments, a heating device is optionally positioned adjacent to the second conduit.

In some embodiments, the systems and methods disclosed herein may be used to introduce an active additive into a subterranean formation through an injection well. In some embodiments, the active additive may be introduced into a subterranean formation through an injection well having a horizontal production well below. A plurality of ports may also be used to inject the active additive at various locations in, for example, an oil and/or gas pipeline or any industrial process where the active additive may be used.

The systems and methods disclosed herein may be used for treating a surface or an aqueous medium. A method may include feeding a composition comprising glycerol through a first conduit and into a second conduit, wherein the second conduit is in fluid communication with the first conduit and the surface or the aqueous medium. The method may also include converting the glycerol into acrolein within the second conduit using an electrochemical converter and introducing the acrolein onto the surface or into the aqueous medium.

In some embodiments, the acrolein can be introduced onto the surface of bedrails, handles, floors, walls, carts, IV stands, wheelchairs, food processing equipment, surgical procedure instruments, diagnostic procedure instruments, such as endoscopes, and general instruments, such as stethoscopes and thermometers.

The presently disclosed systems and methods are applicable to any industry that includes water treatment processes, such as raw water processes, wastewater processes, industrial water processes, municipal water treatment, food and beverage processes, pharmaceutical processes, electronic manufacturing, utility operations, pulp and paper processes, mining and mineral processes, transportation-related processes, textile processes, plating and metal working processes, laundry and cleaning processes, leather and tanning processes, and paint processes.

A medium to which the inactive and/or active additives may be introduced include, for example, an aqueous medium. In certain embodiments, the aqueous medium may comprise water, gas, and/or liquid hydrocarbon. A medium may comprise a liquid hydrocarbon. The liquid hydrocarbon may be any type of liquid hydrocarbon including, but not limited to, crude oil, heavy oil, processed residual oil, bitminous oil, coker oils, coker gas oils, fluid catalytic cracker feeds, gas oil, naphtha, fluid catalytic cracking slurry, diesel fuel, fuel oil, jet fuel, gasoline, and/or kerosene. In certain embodiments, the medium may comprise a refined hydrocarbon product.

The disclosed methods have many advantages over prior methods of delivering active additives. For example, the active additives disclosed herein pose challenges in storage and handling due to their toxicity. The disclosed methods minimize storage and handling of potentially hazardous chemicals, thereby improving safety and decreasing negative environmental effects. In addition, the active additives can be produced on an as-needed basis on-site without the need to transport or store the active additives.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of treating a pipeline, comprising:
feeding an inactive additive through a first conduit and into a second conduit, wherein the second conduit is in fluid communication with the first conduit and is connected to the pipeline;
converting the inactive additive into an active additive with an electrochemical converter in the second conduit; and
introducing the active additive into the pipeline.

2. The method of claim 1, wherein the inactive additive is selected from the group consisting of glycerol, glyceraldehyde, hexamethylenetetramine, methanol, and any combination thereof.

3. The method of claim 1, wherein the active additive is selected from the group consisting of acrolein, ammonia, formaldehyde, and any combination thereof.

4. The method of claim 1, wherein the electrochemical converter comprises an anode, a cathode, and optionally a reference electrode and/or a counter electrode.

5. The method of claim 4, wherein converting the inactive additive into the active additive comprises applying a potential across the anode and the cathode.

6. The method of claim 1, wherein the second conduit comprises a one-way valve.

7. The method of claim 1, wherein the second conduit comprises a catalyst.

8. The method of claim 1, further comprising heating the second conduit.

9. The method of claim 1, wherein the second conduit comprises an electrolyte solution.

10. The method of claim 9, wherein the electrolyte solution comprises glycerol, glyceraldehyde, hexamethylenetetramine, methanol, and any combination thereof.

11. The method of claim 1, wherein the active additive comprises a hydrogen sulfide scavenger, a biocide, a corrosion inhibitor, and any combination thereof.

12. The method of claim 1, wherein the pipeline comprises an oil, a gas, water, and any combination thereof.

13. The method of claim 12, wherein the gas comprises a hydrocarbon gas, hydrogen, carbon dioxide, ammonia, or any combination thereof.

14. A system for treating a pipeline, comprising:
a first conduit;
a second conduit in fluid communication with the first conduit and the pipeline; and
an electrochemical converter disposed within the second conduit.

15. The system of claim 14, further comprising an active additive and/or an inactive additive disposed within the first conduit.

16. The system of claim 14, wherein the second conduit comprises a one-way valve.

17. The system of claim 14, wherein the inactive additive is selected from the group consisting of glycerol, glyceraldehyde, hexamethylenetetramine, methanol, and any combination thereof.

18. The system of claim 14, wherein the active additive is selected from the group consisting of acrolein, ammonia, formaldehyde, and any combination thereof.

19. The system of claim 14, wherein the second conduit comprises a catalyst, an electrolyte solution, and/or a heating element.

20. The system of claim 14, wherein the pipeline comprises an oil, a gas, water, and any combination thereof.
